(19) United States
(12) Patent Application Publication
(10) Pub. No.: US 2025/0373299 A1
(43) Pub. Date: Dec. 4, 2025

(54) METHOD AND APPARATUS FOR UPLINK SIGNAL PRECODING AND REPORTING

(71) Applicant: MEDIATEK INC., Hsinchu City (TW)

(72) Inventors: Yahia Ahmed Mahmoud Mahmoud SHABARA, San Jose, CA (US); Parisa CHERAGHI, San Jose, CA (US)

(21) Appl. No.: 18/876,338

(22) PCT Filed: Jun. 27, 2023
(86) PCT No.: PCT/CN2023/102869

§ 371 Date: Dec. 18, 2024

Related U.S. Application Data
(60) Provisional application No. 63/355,692, filed on Jun. 27, 2022.

(51) Int. Cl. H04B 7/06; H04B 7/10

(52) U.S. Cl. CPC H04B 7/0626; H04B 7/0639; H04B 7/0682; H04B 7/10

(57) ABSTRACT

This disclosure provides a method, an apparatus, and a non-transitory computer-readable medium for wireless communication. In the method, a reference signal is sent from a first device to a second device. The reference signal is used for channel state information (CSI) measurement of a channel between the first device and the second device. A CSI report is received at the first device from the second device. The CSI report indicates a transmit precoder matrix indicator (TPMI) that indicates one of a plurality of precoder matrices. A to-be-transmitted signal is precoded based on the one of a plurality of precoder matrices indicated by the TPMI. Each of the plurality of precoder matrices is able to be used for up to 8-layer transmission.

### INCORPORATION BY REFERENCE

This present disclosure claims the benefit of U.S. Patent Application No. 63/355,692, filed on Jun. 27, 2022, which is incorporated herein by reference in its entirety.

### TECHNICAL FIELD

The present disclosure relates to wireless communications, and specifically to a procedure for uplink signal precoding and reporting.

### BACKGROUND

In wireless communications, channel state information (CSI) can be used for estimating channel properties of a communication link between a transmitter and a receiver. In related arts, the receiver can estimate the CSI of the communication link and feedback the raw CSI to a transmitter. This procedure can consume a great deal of communication resources and place a tremendous strain on a wireless network using modern multiple-input and multiple-output (MIMO) technology.

### SUMMARY

Aspects of the disclosure provide a method for wireless communication at a first device. In the method, a reference signal is sent from a first device to a second device. The reference signal is used for channel state information (CSI) measurement of a channel between the first device and the second device. A CSI report is received at the first device from the second device. The CSI report indicates a transmit precoder matrix indicator (TPMI) that indicates one of a plurality of precoder matrices. A to-be-transmitted signal is precoded based on the one of a plurality of precoder matrices indicated by the TPMI. Each of the plurality of precoder matrices is able to be used for up to 8-layer transmission.

In an embodiment, the first device is equipped with 8 antenna ports for transmission, the 8 antenna ports being grouped into a single panel or multiple panels. In an example, the 8 antenna ports are fully coherent to each other.

In an embodiment, the plurality of precoder matrices is classified into three matrix sets each corresponding to one of three codebook modes 1-3, each matrix set including 8 columns of precoder matrices.

In an embodiment, in each matrix set, column 1 defines a general structure, column 2 adds a 180° phase shift for inter-polarization co-phasing values with respect to column 1, column 3 adds a 180° phase shift for inter-panel co-phasing values for all panels with an odd index, with respect to column 1, column 4 adds a 180° phase shift for inter-panel co-phasing values for all panels with an odd index, with respect to column 2, column 5 adds a 90° phase shift for inter-polarization co-phasing values with respect to column 1, column 6 adds a −90° phase shift for inter-polarization co-phasing values with respect to column 1, column 7 adds a 180° phase shift for inter-panel co-phasing values for all panels with an odd index, with respect to column 5, and column 8 adds a 180° phase shift for inter-panel co-phasing values for all panels with an odd index, with respect to column 6.

In an embodiment, N_{g} represents a number of antenna panels that antenna ports of the UE are grouped into, codebook mode 1 includes N_{g} co-phasing values, codebook mode 2 includes 4N_{g}−3 co-phasing values, and codebook mode 3 includes 2N_{g}−1 co-phasing values.

In an embodiment, the CSI report is a dual-stage report including a first stage report indicating slow-changing indices that are reported with low periodicity and a second stage report indicating fast-changing indices that are reported with high periodicity.

In an embodiment, codebook mode 1 includes N_{g}−1 inter-panel co-phasing values that are indicated by the first stage report and one panel-common inter-polarization co-phasing value that is indicated by the second stage report.

In an embodiment, codebook mode 2 includes 2N_{g}−2 co-phasing values that are indicated by the first stage report and 2N_{g}−1 co-phasing values that are indicated by the second stage report.

In an embodiment, the CSI report is a single-stage report indicating all the co-phasing values in codebook mode 3.

In an embodiment, the first device and the second device are a user equipment and a base station, respectively.

In an embodiment, the first device and the second device are a base station and a user equipment, respectively.

Aspects of the disclosure provide a first device including processing circuitry that sends, to a second device, a reference signal for CSI measurement of a channel between the first device and the second device. The processing circuitry receives, from the second device, a CSI report indicating a TPMI that indicates one of a plurality of precoder matrices. The processing circuitry precodes a to-be-transmitted signal based on the one of a plurality of precoder matrices indicated by the TPMI. Each of the plurality of precoder matrices is able to be used for up to 8-layer transmission.

Aspects of the disclosure provide a non-transitory computer-readable medium storing instructions which when executed by an apparatus cause the apparatus to perform any one or a combination of the above methods.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary procedure of reporting CSI according to embodiments of the disclosure;

FIG. 2 shows examples of grouping 8 cross-polarized antenna ports according to embodiments of the disclosure;

FIG. 3 shows exemplary precoder matrices according to embodiments of the disclosure;

FIGS. 4A-4C show three exemplary precoder matrix sets M₁-M₃, respectively, according to embodiments of the disclosure;

FIGS. 5A-5G show exemplary codebooks according to embodiments of the disclosure;

FIG. 6 shows a flowchart outlining a process according to embodiments of the disclosure; and

FIG. 7 shows an exemplary apparatus according to embodiments of the disclosure.

### DETAILED DESCRIPTION OF EMBODIMENTS

The detailed description set forth below in connection with the appended drawings is intended as a description of various configurations and is not intended to represent the only configurations in which the concepts described herein may be practiced. The detailed description includes specific details for the purpose of providing an understanding of various concepts. However, these concepts may be practiced without these specific details.

Several aspects of telecommunication systems will now be presented with reference to various apparatuses and methods. These apparatuses and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

In wireless communications, channel state information (CSI) can be used for estimating channel properties of a communication link between a transmitter and a receiver. For example, CSI can describe how a signal propagates from the transmitter to the receiver and can represent a combined effect of phenomena such as scattering, fading, power loss with distance, and the like. Thus, CSI can also be referred to as channel estimation. CSI can make it feasible to adapt the transmission between the transmitter and the receiver to current channel conditions, and thus is a critical piece of information that needs to be shared between the transmitter and the receiver to allow high-quality signal reception.

In an example, the transmitter and the receiver (or transceivers) can rely on CSI to compute their transmit precoding and receive combining matrices, among other important parameters. Without CSI, a wireless link may suffer from a low signal quality and/or a high interference from other wireless links.

To estimate CSI, the transmitter can send a predefined signal to the receiver. That is, the predefined signal is known to both the transmitter and the receiver. The receiver can then apply various algorithms to perform CSI estimation. At this stage, CSI is known to the receiver only. The transmitter can rely on feedback from the receiver for acquiring CSI knowledge.

Raw CSI feedback, however, may require a large overhead which may degrade the overall system performance and cause a large delay. Thus, the raw CSI feedback is typically avoided.

Alternatively, from CSI, the receiver can extract some important or necessary information for the transmitter operations, such as a transmit precoder matrix indicator (TPMI), precoding weights, a rank indicator (RI), a channel quality indicator (CQI), a modulational and coding scheme (MCS), a sounding reference signal indicator (SRI), and the like. The extracted information can be much smaller than the raw CSI, and the receiver can only feedback these small pieces of information to the transmitter, striking a balance between feedback overhead and achievable performance.

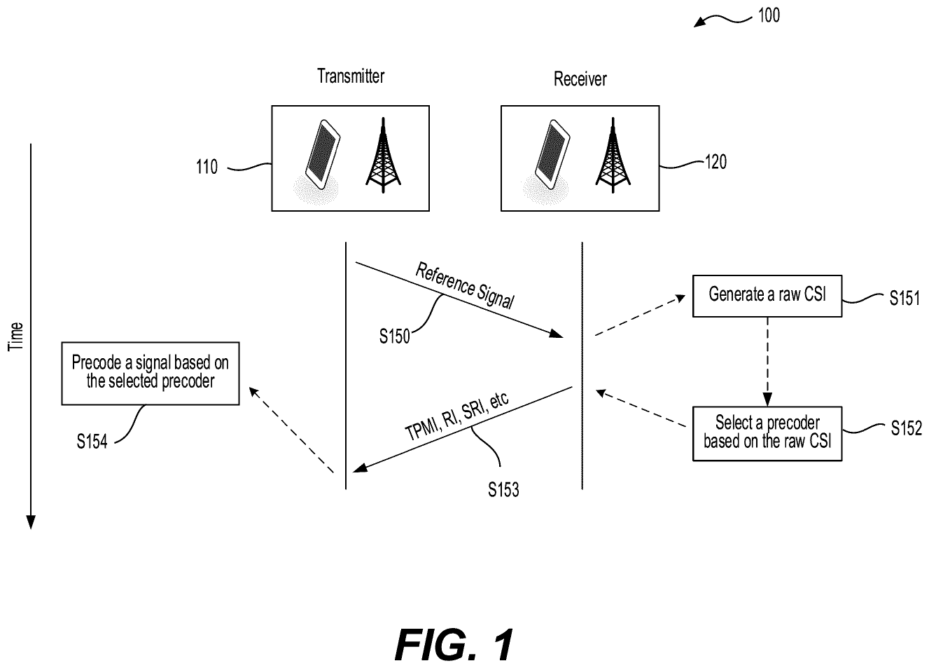

FIG. 1 shows an exemplary procedure 100 of reporting CSI according to embodiments of the disclosure. In the procedure 100, each of a transmitter 110 and a receiver 120 can be a user equipment (UE) or a base station (BS). In this disclosure, a transmission from the transmitter 110 to the receiver 120 is referred to as an uplink (UL) transmission, and a transmission from the receiver 120 to the transmitter 110 is referred to as a downlink (DL) transmission.

At step S150, the transmitter 110 can transmit a reference signal (RS) to the receiver 120. The RS is also known to the receiver 120 before the receiver 120 receives the RS. In an embodiment, the RS can be specifically intended to be used by devices to acquire CSI and thus is referred to as CSI-RS.

At step S151, after receiving the CSI-RS, the receiver 120 can generate a raw CSI by analyzing the received CSI-RS using the transmitted CSI-RS that is already known to the receiver 120.

At step S152, the receiver 120 can select a best transmitting precoder matrix from a set of predefined precoder matrices based on the raw CSI. The set of predefined precoder matrices can be referred to as a precoder codebook. The best transmitting precoder matrix can be identified by a TMPI, which is a type of downlink control information (DCI).

At step S153, the receiver 120 can send the TPMI of the selected precoder matrix back to the transmitter 110, along with relevant information such as CQI, RI, MCS, SRI, and the like. The TPMI can inform the UE which precoder matrix can be used for precoding a to-be-transmitted signal.

At step S154, after receiving the TPMI and the relevant information, the transmitter 110 can determine transmission parameters and pre-code the to-be-transmitted signal based on the selected precoder matrix identified by the TPMI.

According to aspects of the disclosure, multiple antenna ports of a UE can be grouped into a single group or multiple groups. The antenna ports within each antenna group can be uniformly spaced.

3GPP TS 38.211 and TS 38.214 provide codebooks for the UL and DL transmission, respectively. The DL codebooks in 3GPP TS 38.214 can support up to 32 antenna ports in both single-panel (i.e., single group) and multi-panel (i.e., multiple groups) configurations, while the UL codebooks in 3GPP TS 38.211 can only support up to 4 antenna ports in single-panel configuration. The UL and DL codebooks provided in 3GPP TS 38.211 and TS 38.214 are referred to as legacy codebooks in this disclosure.

As development of wireless communication, the UL transmission can support more than 4 antenna ports. For example, a UE can be equipped with 8 antenna ports for the UL transmission.

This disclosure provides various precoder codebooks that can support more than 4 antenna ports for the UL transmission. The provided codebooks can be referred to as UL codebooks in this disclosure.

According to aspects of the disclosure, the UL codebooks can support fully coherent antenna ports. That is, a relative phase coherence can be controlled among all antenna ports in transmission, and a linear combination of data input over all antenna ports can be allowed. The UL codebooks can support to an entire band (e.g., with a wideband configuration). For example, the UL codebooks can assume the entire band to be one big sub-band that spans an entire bandwidth.

According to aspects of the disclosure, the UL codebooks can support both single-panel and multi-panel configurations. That is, all antenna ports for transmission can be grouped into a single antenna group or multiple antenna groups. For example, the UL codebooks can support up to 4 antenna groups for 8 cross-polarized antenna ports.

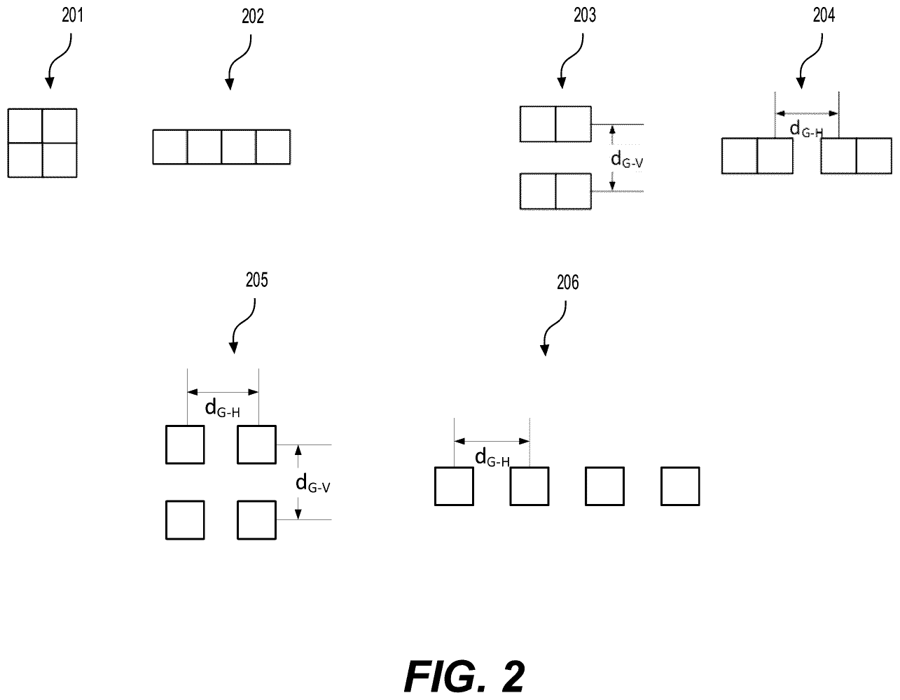

FIG. 2 shows examples of grouping 8 cross-polarized antenna ports according to embodiments of the disclosure. In FIGS. 2, N₁ and N₂ are numbers of horizontal and vertical cross-polarized antennas per antenna group. In an example, the 8 cross-polarized antenna ports can be grouped into a single group as a 2×2 (N₁=N₂=2) array in a first arrangement 201 or a 4×1 (N₁=4, N₂=1) array in a second arrangement 202. In example, the 8 cross-polarized antenna ports can be grouped into two groups each being a 2×1 (N₁=2, N₂=1) array. The two groups can be arranged as a third arrangement 203 or a fourth arrangement 204. In an example, the 8 cross-polarized antenna ports can be grouped into four groups each being a 1×1 (N₁=1, N₂=1) array. The four groups can be arranged as a fifth arrangement 205 or a sixth arrangement 206. In these arrangements, d_{G-H} and d_{G-V} are horizontal and vertical separations between two adjacent groups, respectively.

According to aspects of the disclosure, each precoder matrix in the UL codebooks can have co-phased discrete Fourier transform (DFT) beams as columns of the respective matrix. For example, a single-panel precoder matrix with co-phased DFT beams as columns can be expressed as

$$w = ( \begin{matrix}{v}_{0} & {v}_{1} & … & {v}_{R - 1} \\ {e}^{j {Φ}_{0}} {v}_{0} & {e}^{j {Φ}_{1}} {v}_{1} & … & {e}^{j {Φ}_{R - 1}} {v}_{R - 1}\end{matrix} ) ,$$

where R is a number of transmission layers (or transmission ranks), vᵢ∈{0, 1, . . . , R−1} is a DFT beam of a first polarization on layer i, and e^{jϕ}^{ᵢ}vᵢ is a DFT beam of a second polarization on layer i. ϕᵢ is a co-phasing value of the second polarization on layer i and can be referred to as an inter-polarization co-phasing value (or parameter).

To indicate a specific matrix W, only the DFT beams vᵢ and the co-phasing values ϕᵢ need to be specified. The DFT beams vᵢ and the co-phasing values ϕᵢ can take values from predefined sets. The predefined sets can be dependent on a number of layers (rank-dependent).

For the fully coherent antenna ports, the DFT beams vᵢ can be oversampled with oversampling factors (O₁, O₂), where O₁ and O₂ are used to increase the DFT beam resolution in horizontal and vertical directions, respectively. The oversampling factor O (either O₁ or O₂) can be configured with values in {1, 2, 3, 4, . . . }.

Accordingly, an oversampled DFT beam can be defined as

$${v}_{l , m} = {v}_{l}^{( H )} ⊗ {v}_{m}^{( V )} ,$$

where ⊗ represents Kronecker product.

$${v}_{l}^{( H )} and {v}_{m}^{( V )}$$

represent the oversampled DFT beam in horizontal and vertical directions, respectively, and can be expressed as

$${v}_{l}^{( H )} = ( \begin{matrix}1 \\ {exp}^{j \frac{2 π l}{{O}_{1} {N}_{1}}} \\ ⋮ \\ {exp}^{j \frac{2 π l ( {N}_{1} - 1 )}{{O}_{1} {N}_{1}}}\end{matrix} ) {v}_{m}^{( V )} = ( \begin{matrix}1 \\ {exp}^{j \frac{2 π m}{{O}_{2} {N}_{2}}} \\ ⋮ \\ {exp}^{j \frac{2 π m ( {N}_{2} - 1 )}{{O}_{2} {N}_{2}}}\end{matrix} )$$

where N₁ and N₂ are numbers of horizontal and vertical cross-polarized antennas per antenna group, respectively, and O₁ and O₂ are horizontal and vertical oversampling factors of the oversampled DFT beam, respectively.

The oversampled DFT beam v_{l,m} can be specified as vᵢ_{_{1,1}}ᵢ_{_{1,2}}, where i_{1,1}∈{0, 1, . . . , N₁O₁−1} is an index of the oversampled DFT beam in the horizontal direction, and i_{1,2} ∈{0, 1, . . . , N₂O₂−1} is an index of the oversampled DFT beam in the vertical direction. Another DFT beam relative to the oversampled DFT beam can be specified as vᵢ_{_{1,1}}₊ₖ_{₁}_{,i}_{_{1,2}}₊ₖ_{₂}, where k₁ and k₂ are beam index offsets in the horizontal and vertical directions, respectively. An index i_{1,3} can be mapped to the beam index offsets k₁ and k₂.

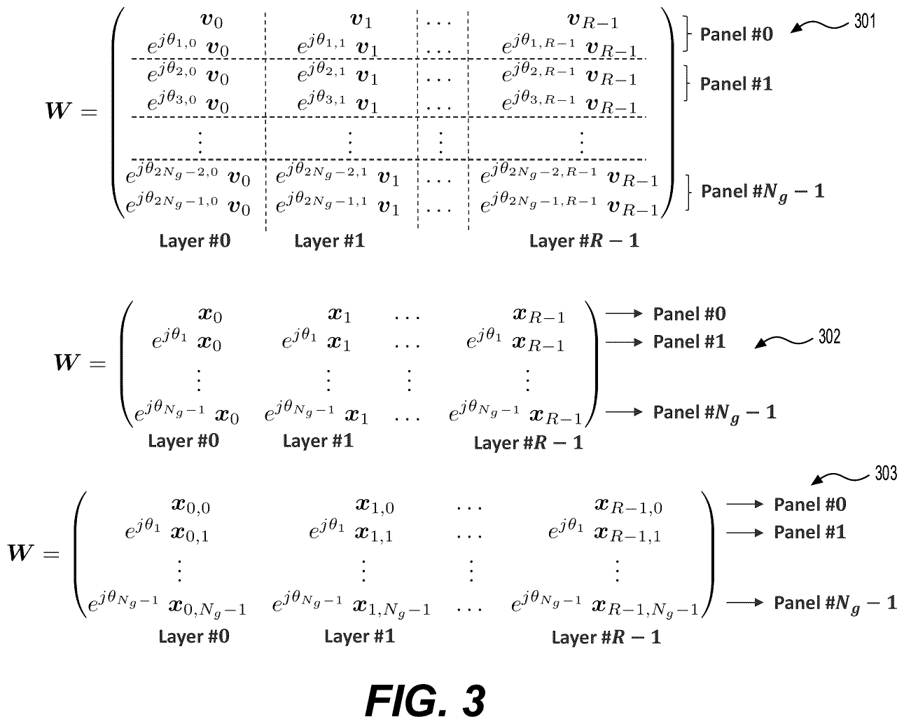

FIG. 3 shows exemplary precoder matrices 301-303 according to embodiments of the disclosure. The precoder matrix 301 is a general precoder matrix and can be used as a single-panel matrix or a multi-panel matrix. In the precoder matrix 301, R is a number of transmission layers (or transmission ranks), N_{g} is a number of antenna panels, vᵣ is a DFT beam of layer r, and θ_{i,r} is an inter-polarization and inter-panel co-phasing value of layer r, where r∈{0, 1, . . . , R−1}, i∈{1, . . . , 2N_{g}−1}. It can be seen that the DFT beams in the precoder matrix 301 can be represented by the DFT beam parameters N_{g}, R, N₁, N₂, O₁, O₂, i_{1,1}, i_{1,2}, and i_{1,3}, all of which can considered as slow-changing parameters that are reported with low periodicity. Further, parameters representing the co-phasing values can include slow-changing parameter p (or i_{1,4}) and fast-changing parameter n (or i₂) that is reported with high periodicity.

The precoder matrix 302 is a panel-common precoder matrix, in which the DFT beams can be same for the same layer across all panels.

The precoder matrix 303 is a panel-independent precoder matrix, in which the DFT beams can be independent to each other for the same layer across all panels.

In an embodiment, at least one of the UL codebooks can support a dual stage reporting, in which a first stage reporting can report the DFT beam parameters and the slow-changing parameter of the co-phasing values, and a second stage reporting can report fast-changing parameter of the co-phasing values. For example, in the first stage (or stage 1), i₁={i_{1,1}, i_{1,2}, i_{1,3}, i_{1,4}} can be reported, and in the second stage (or stage 2), i₂ can be reported.

According to aspects of the disclosure, each of the UL codebooks can be classified into one of three codebook modes, which can be referred to as codebook modes 1-3, respectively. Each codebook mode can support up to 8 transmission layers (or ranks) and up to 4 panels with 8 antenna ports. Codebook modes 1-3 are based on imposing different restrictions on choices of beams v and co-phasing e^{jθ} of the precoder matrix 301, and thus can provide different tradeoffs between accuracy and feedback overhead.

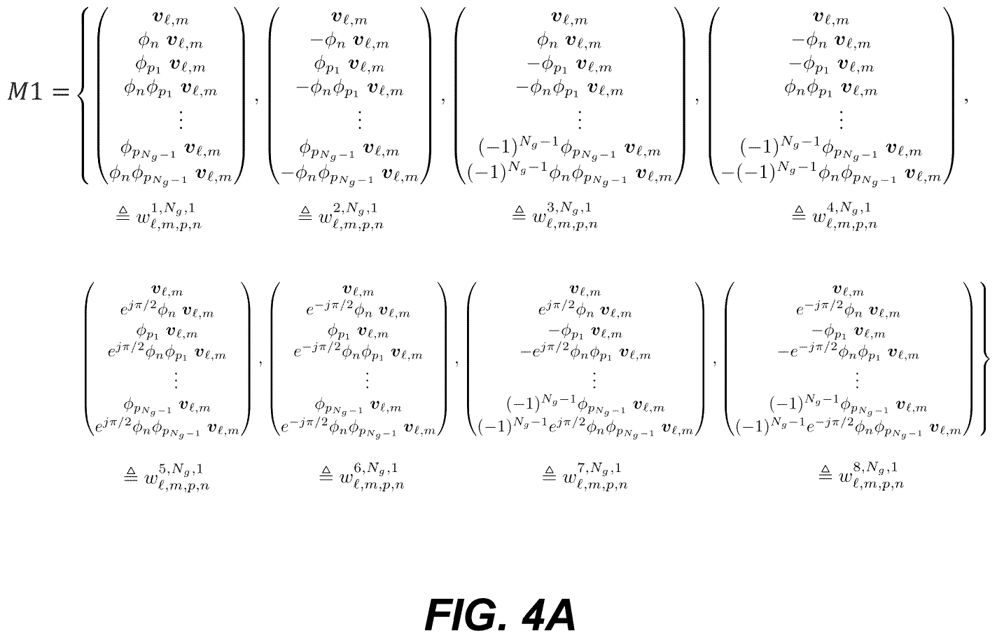

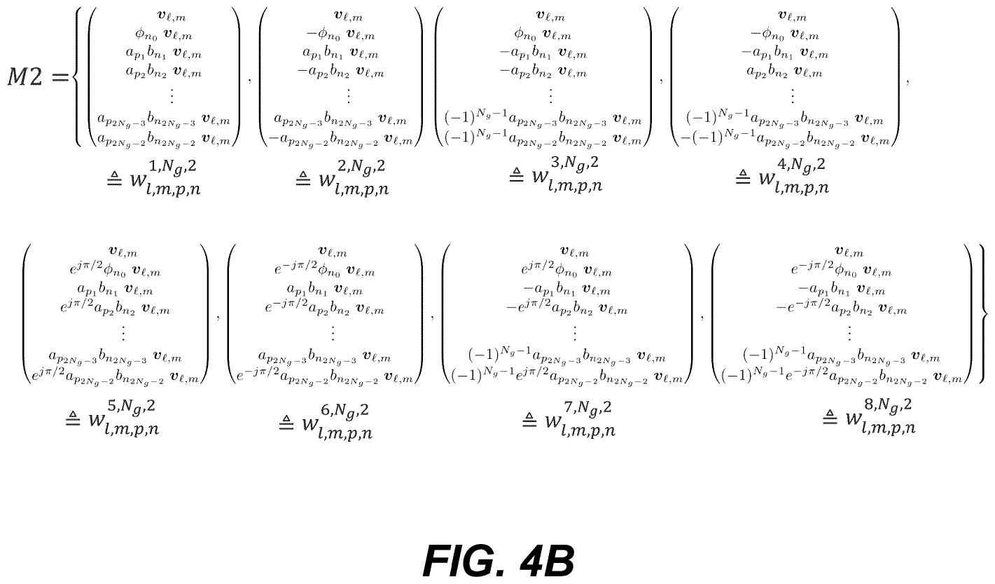

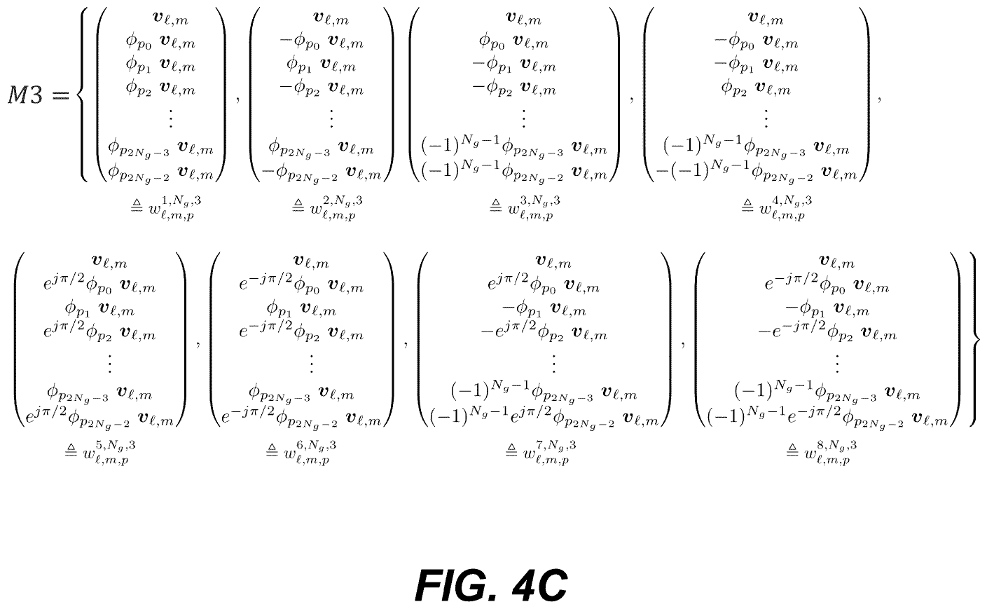

FIGS. 4A-4C show three exemplary precoder matrix sets M₁-M₃, respectively, according to embodiments of the disclosure. The three precoder matrix sets M₁-M₃ can correspond to codebook modes 1-3, respectively. Columns of each precoder matrix set M₁-M₃ can be denoted by

$${w}_{l , m , p , n}^{i , {N}_{g} , mode} ,$$

where i is a column index in the matrix set, N_{g} is a number of antenna groups (or panels), mode is a codebook mode number, l, m are the horizontal and vertical beam indices, respectively, and p, n denote stage 1 and stage 2 co-phasing parameters, respectively.

All the three precoder matrix sets M₁-M₃ can be constructed in a similar way as follows.

In each matrix set corresponding to a respective codebook mode, a first column (i=1) can define a general structure. A second column (i=2) adds a 180° phase shift for inter-polarization co-phasing parameters with respect to column 1. A third column (i=3) adds a 180° phase shift for inter-panel co-phasing parameters for all panels with an odd index, with respect to column 1. A fourth column (i=4) adds a 180° phase shift for inter-panel co-phasing parameters for all panels with an odd index, with respect to column 2. A fifth column (i=5) adds a 90° phase shift for inter-polarization co-phasing parameters, with respect to column 1. A sixth column (i=6) adds a −90° phase shift for inter-polarization co-phasing parameters, with respect to column 1. A seventh column (i=7) adds a 180° phase shift for inter-panel co-phasing values for all panels with an odd index, with respect to column 5. An eighth column (i=8) adds a 180° phase shift for inter-panel co-phasing parameters for all panels with an odd index, with respect to column 6.

The differences among the three precoder matrix sets M₁-M₃ are in the co-phasing parameters.

Specifically, the precoder matrix set M₁ of the codebook mode 1 includes a total of N_{g} co-phasing parameters that include N_{g}−1 inter-panel co-phasing parameters Øₚ_{₁}-Ø_{PN}_{_{g-1}} and one panel-common inter-polarization co-phasing parameter Øn which is identical across all panels. The inter-polarization co-phasing can be defined in reference to the first polarization. The inter-panel co-phasing parameters can be specified per panel, for all panels except the first panel which is used as reference. The codebook mode 1 can support the dual-stage reporting, where the stage 1 reporting can report the slow-changing parameters i₁=[i_{1,1}, i_{1,2}, i_{1,3}, i_{1,4}], where i_{1,4}=p=[p₁, p₂, . . . , p_{N}_{_{g}}₋₁], and stage 2 reporting can report the fast-changing parameter i₂=n.

The precoder matrix set M₂ of the codebook mode 2 includes a total of 4N_{g}−3 co-phasing parameters that include 2N_{g}−2 slow-changing co-phasing parameter:

$$( e . g . , {a}_{{p}_{1}} , … , {a}_{{p}_{2 {N}_{g} - 2}} )$$

the stage 1 and 2N_{g}−1 fast-changing co-phasing parameters

$$( e . g . , {ϕ}_{{n}_{0}} , {b}_{{n}_{1}} , … , {b}_{{n}_{2 {N}_{g} - 2}} )$$

for the stage 2. In the dual-stage reporting, the inter-polarization and inter-panel co-phasing parameters can be combined for both reporting stages. The stage 1 co-phasing parameters can be specified for all panels and all polarization within the panels, except for the first panel. The stage 2 co-phasing parameters can be specified for all panels and all polarization within the panels, except for the first panel. For the first panel, a single parameter can represent the stage 2 inter-polarization co-phasing parameter for the second polarization. The stage 1 reporting can report the slow-changing parameters i₁=[i_{1,1}, i_{1,2}, i_{1,3}, i_{1,4}], where i_{1,4}=p=[p₁, p₂, . . . , p_{2N}_{_{g}}₋₂]. The stage 2 reporting can report the fast-changing parameter i₂=n=[n₀, n₁, . . . , N_{2N}_{_{g}}₋₂]. In the precoder matrix set M₂,

$${ϕ}_{n} = {e}^{\frac{j π n}{2}} , {a}_{p} = {e}^{\frac{j π}{4}} {e}^{\frac{j π p}{2}} , and {b}_{n} = {e}^{\frac{- j π}{4}} {e}^{\frac{j π n}{2}} .$$

The precoder matrix set M₃ of the codebook mode 3 includes a total of 2N_{g}−1 inter-polarization and inter-panel co-phasing parameters Øₚ_{₀}-Øₚ_{₂}_{N}_{_{g}}₋₂. In comparison to the codebook mode 2, aₚ and bₙ are replaced by ϕ_{y} in the codebook mode 3. In the codebook mode 3, the inter-polarization and inter-panel co-phasing parameters can be specified for all panels and all polarization within the panels, with the first polarization of the first panels acting as reference. The codebook mode 3 can support the single-stage reporting which reports i₁=[i_{1,1}, i_{1,2}, i_{1,3}, i_{1,4}], where i_{1,4}=p=[p₀, p₁, p₂, . . . , p_{2N}_{_{g}}₋₂].

It can be seen that among the three codebook modes, the codebook mode 1 has the lowest overhead (i.e., the lowest total number of co-phasing parameters) and thus the lowest accuracy, the codebook mode 2 has the highest overhead (i.e., the highest total number of co-phasing parameters) and thus the highest accuracy, and the codebook mode 3 provides a trade-off between the overhead and the accuracy compared to the codebook modes 1 and 2.

In a fast-changing environment such as for a moving UE, the precoder matrix needs to be updated in a short period, so that a low overhead of the TPMI feedback is preferred, and thus the codebook mode 1 can be utilized. In a slow-changing environment such as for a fixed UE, the precoder matrix can be updated in a long period, so that a high overhead of the TMPI feedback can be utilized to achieve a high accuracy. In such a case, the codebook mode 2 can be used. In an intermediate environment, the codebook mode 3 can be chosen for UL transmission.

The UL codebooks can utilize flexible DFT oversampling and flexible co-phasing resolution. The UL codebooks can be a superset of, equal to, or a subset of the legacy Type I codebooks including single-panel DL, multi-panel DL, and single-panel UL codebooks. The UL codebooks can be a concatenation of co-phased matrices drawn from the legacy 2TX/4TX UL precoder tables (defined in TS 38.211).

For all codebook modes, the DFT oversampling factors (O₁≥1 and O₂≥1) can be kept the same as in legacy DL codebooks or can either be increased or reduced compared to the legacy DL codebooks. A reduced value can give a subset of the DL DFT beams, or a reduced spatial resolution. An increased value can give a superset of the DL DFT beams, or an increased spatial resolution. If N₁=1, then O₁=1, and i_{1,1}=0 shall not be reported. If N₂=1, then O₂=1, and i_{1,2}=0 shall not be reported. If i_{1,3} can only be a single value, it shall not be reported.

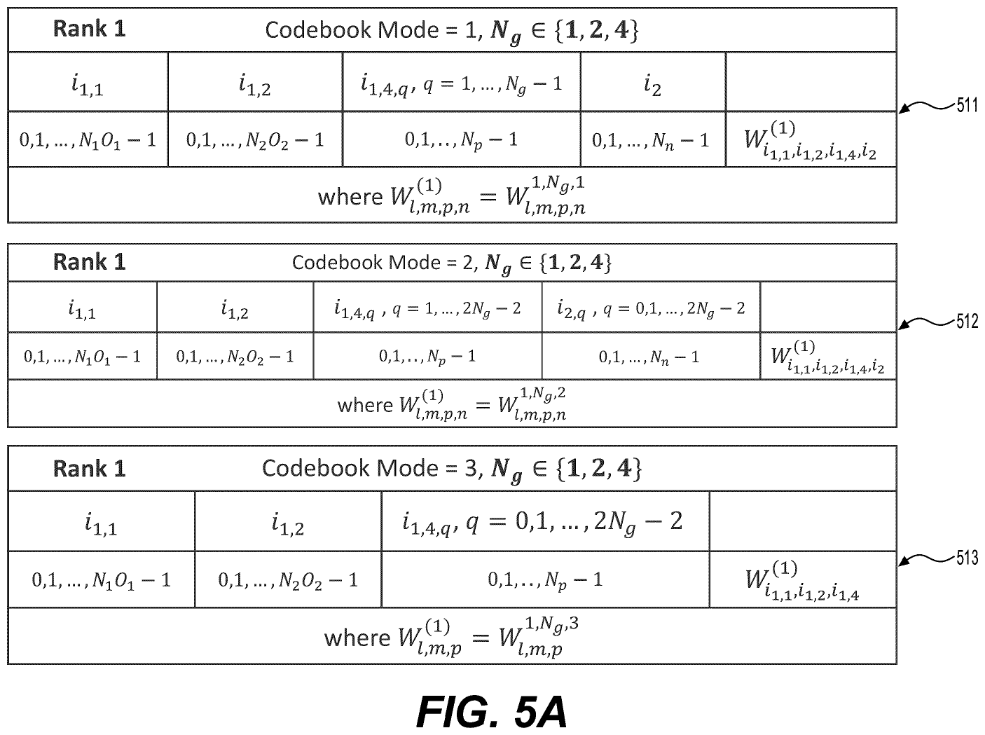

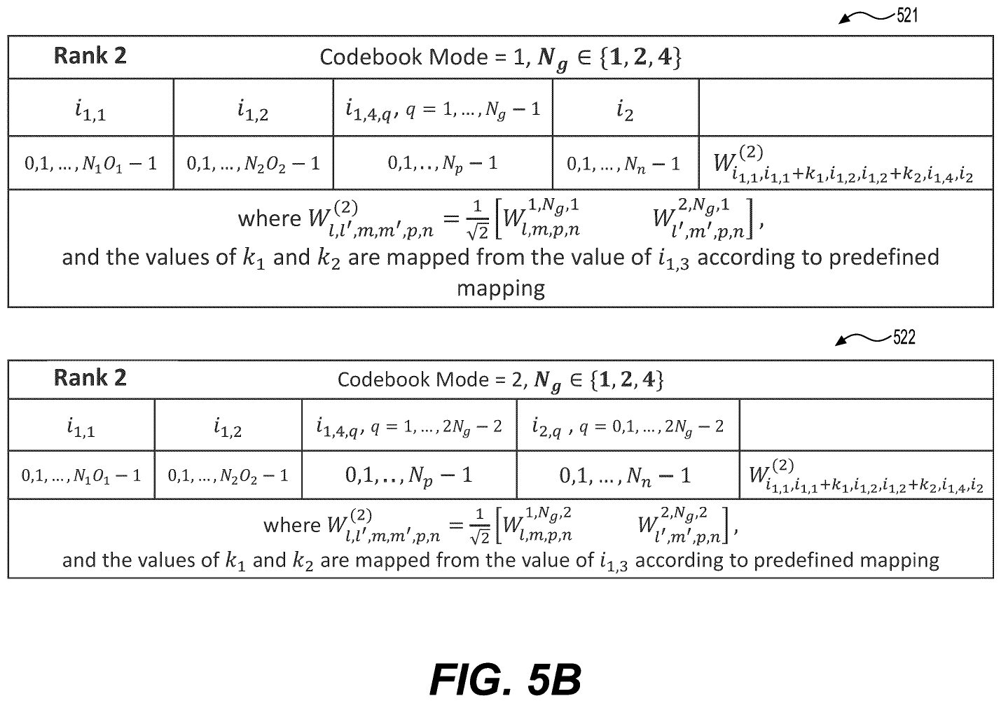

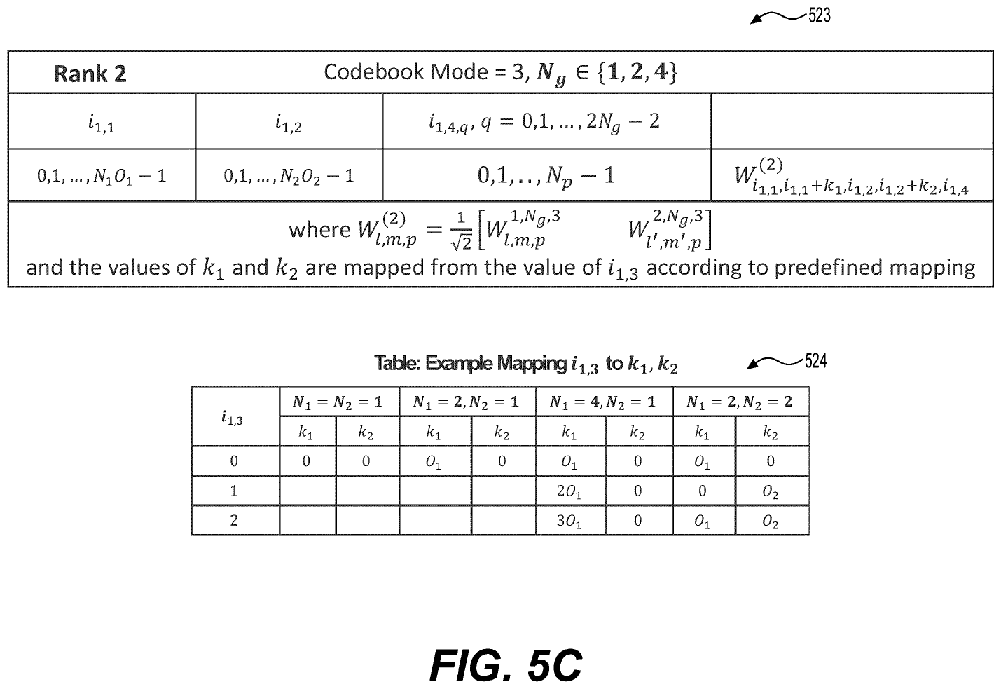

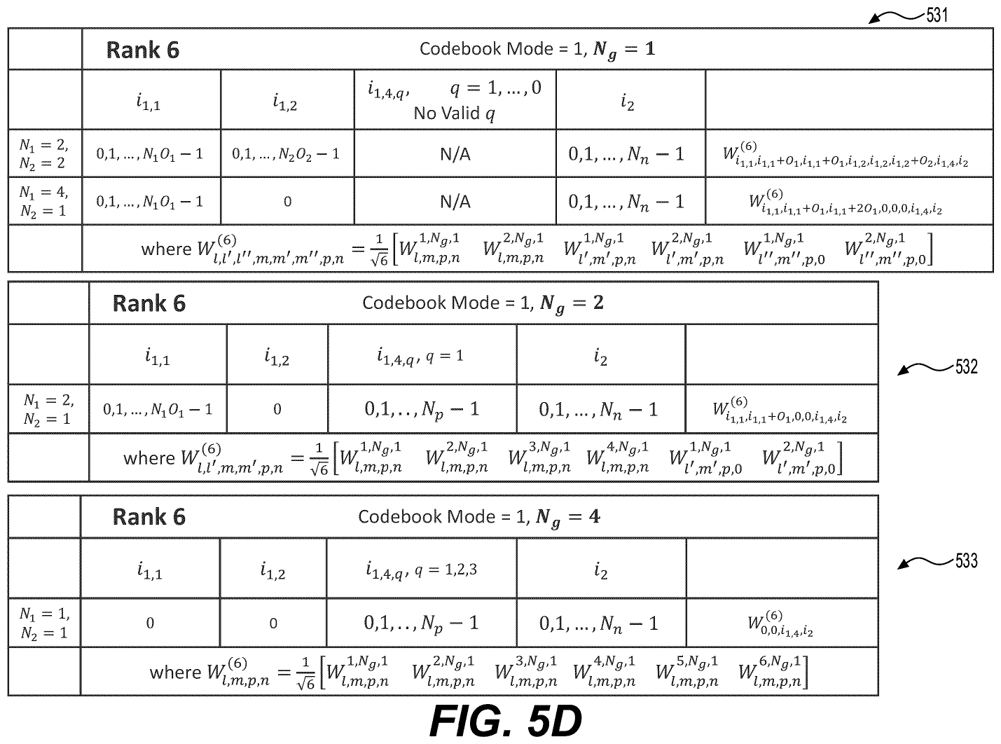

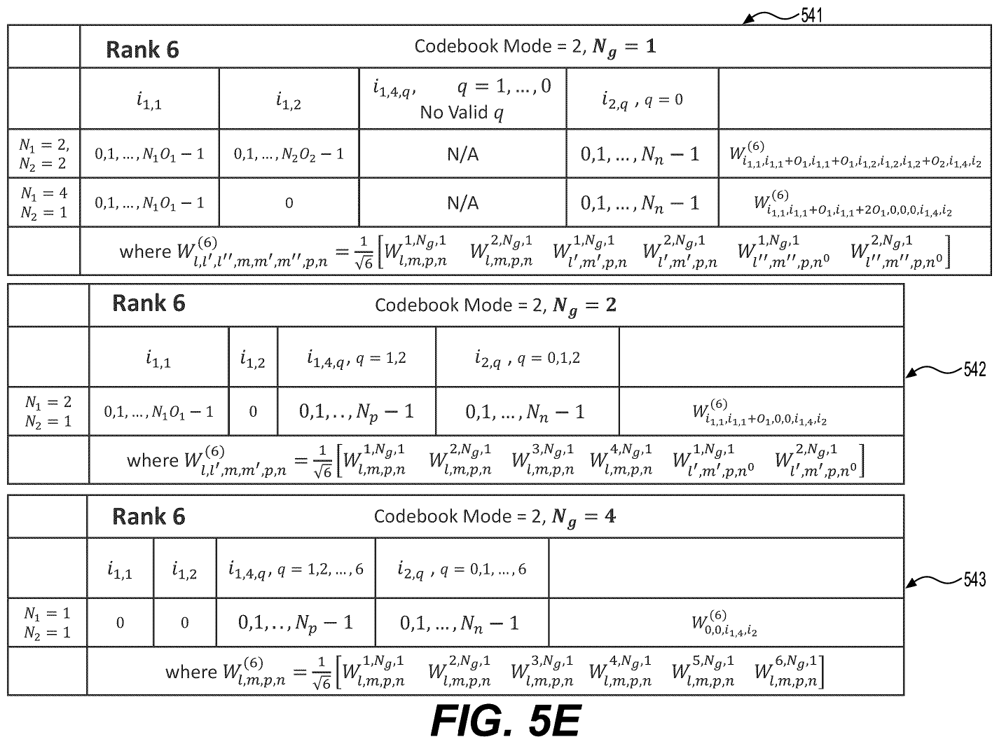

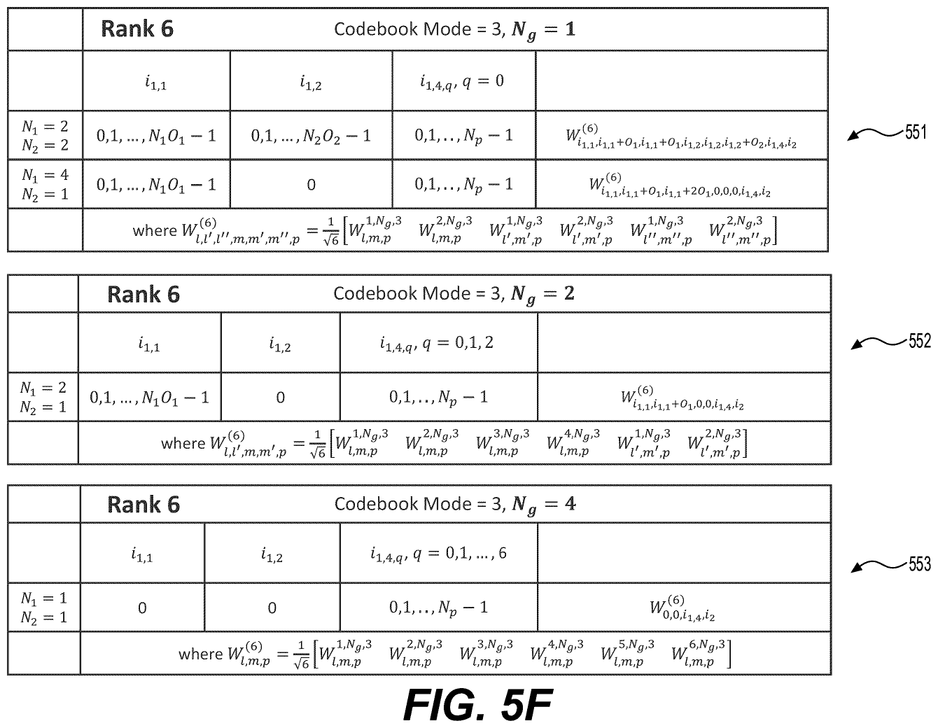

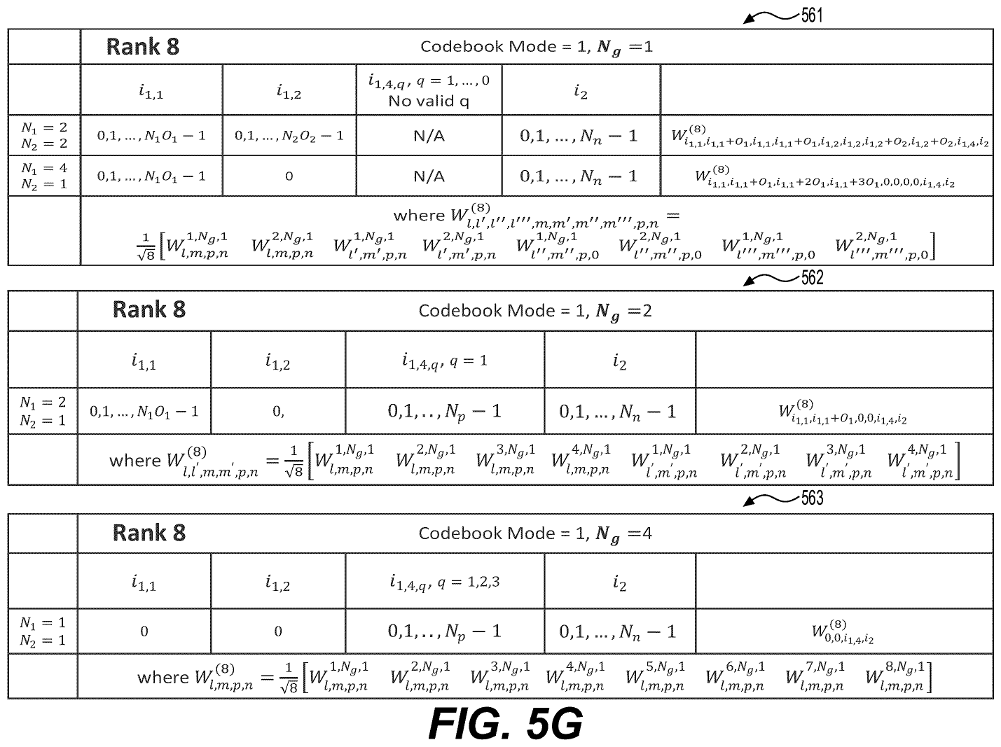

FIGS. 5A-5G show exemplary codebooks according to embodiments of the disclosure. In the codebooks, the oversampling factors O₁ and O₂ can be any positive integer, for example, 1, 2, or 4. Nₚ and Nₙ can be set as 4, or can be lowered to reduce the overhead and sacrifice a precoder accuracy, or can be increased to increase the overhead but have a higher accuracy.

In the codebook mode 1, by appropriately selecting the oversampling factors O₁ and O₂, the offsets k₁ and k₂, as well as the resolution for inter-polarization co-phasing parameters, a co-phased (across panels) concatenation of precoders from the UL 2TX or 4TX precoder codebook can be obtained.

The codebooks 511-513 in FIG. 5A correspond to codebook modes 1-3 for layer 1 (or rank 1), respectively. When N_{g}=2, N₁=O₁=2, N₂=O₂=1, and Nₙ=4, the codebook 511 can be a concatenation of two precoders from the coherent subset of UL 4 TX single-layer codebook defined in TS38.211 Table 6.3.1.5-3.

The codebooks 521-523 in FIGS. 5B-5C correspond to codebook modes 1-3 for layer 2 (or rank 2), respectively. Table 524 is an example of mapping i_{1,3} to k₁, k₂. When N_{g}=2, (N₁, N₂)=(2,1), (O₁, O₂)=(1,1), k₁=k₂=0 (i_{1,3}=0), and Nₙ=2, the codebook 521 can be a concatenation of two precoders from the coherent subset of UL 4 TX two-layer codebook defined in TS38.211 Table 6.3.1.5-5.

The codebooks 531-533 in FIG. 5D correspond to codebook mode 1 for layer 6 (or rank 6). The codebooks 541-543 in FIG. 5E correspond to codebook mode 2 for layer 6 (or rank 6), where n⁰=[0, 0, . . . , 0].

The codebooks 551-553 in FIG. 5F correspond to codebook mode 3 for layer 6 (or rank 6).

The codebooks 561-563 in FIG. 5G correspond to codebook mode 1 for layer 8 (or rank 8).

### Flowchart

This disclosure provides UL precoder matrices for more than 4 TX ports, where columns of the precoder matrices are co-phased DFT beams. Accordingly, TPMI can be specified using beam and phase indices. Both beam and phase choices can take value from predetermined sets. Such sets can be rank-dependent to balance between the system performance and the overhead level.

The beam sets (and precoder matrices) can be expressed using mathematical equations to avoid listing all codebook entries in tabular format. The beam sets for different ranks can have different oversampling factors. Precoders for partially coherent mode can be determined based on the precoders (or a subset of the precoders with an appropriate size) for UL fully coherent mode.

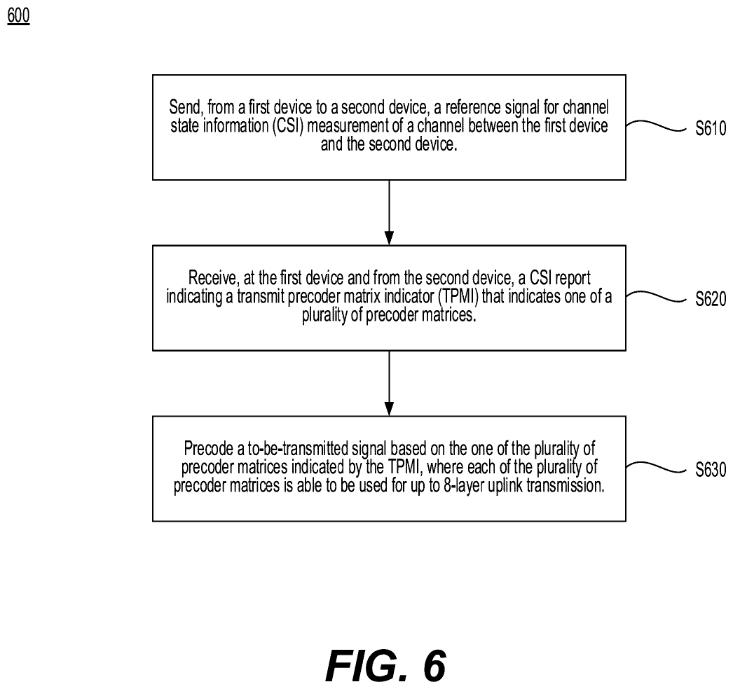

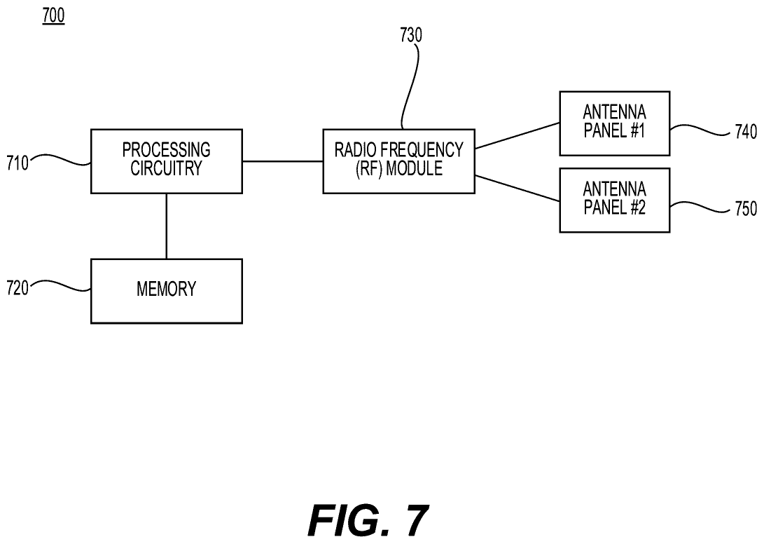

FIG. 6 shows a flowchart outlining a process 600 according to embodiments of the disclosure. The process 600 can be executed by processing circuitry of a first device such as apparatus 700 in FIG. 7. The process 600 may start at step S610.

At step S610, the process 600 sends, to a second device, a reference signal for CSI measurement of a channel between the first device and the second device. Then, the process 600 proceeds to step S620.

At step S620, the process 600 receives, from the second device, a CSI report indicating a TPMI that indicates one of a plurality of precoder matrices. Then, the process 600 proceeds to step S630.

At step S630, the process 600 precodes a to-be-transmitted signal based on the one of the plurality of precoder matrices indicated by the TPMI. Each of the plurality of precoder matrices is able to be used for up to 8-layer transmission.

In an embodiment, the first device is equipped with 8 antenna ports for transmission, the 8 antenna ports being grouped into a single panel or multiple panels. In an example, the 8 antenna ports are fully coherent to each other.

In an embodiment, the plurality of precoder matrices is classified into three matrix sets each corresponding to one of three codebook modes 1-3, each matrix set including 8 columns of precoder matrices.

In an embodiment, in each matrix set, column 1 defines a general structure, column 2 adds a 180° phase shift for inter-polarization co-phasing values with respect to column 1, column 3 adds a 180° phase shift for inter-panel co-phasing values for all panels with an odd index, with respect to column 1, column 4 adds a 180° phase shift for inter-panel co-phasing values for all panels with an odd index, with respect to column 2, column 5 adds a 90° phase shift for inter-polarization co-phasing values with respect to column 1, column 6 adds a −90° phase shift for inter-polarization co-phasing values with respect to column 1, column 7 adds a 180° phase shift for inter-panel co-phasing values for all panels with an odd index, with respect to column 5, and column 8 adds a 180° phase shift for inter-panel co-phasing values for all panels with an odd index, with respect to column 6.

In an embodiment, N_{g} represents a number of antenna panels that antenna ports of the UE are grouped into, codebook mode 1 includes N_{g} co-phasing values, codebook mode 2 includes 4N_{g}−3 co-phasing values, and codebook mode 3 includes 2N_{g}−1 co-phasing values.

In an embodiment, the CSI report is a dual-stage report including a first stage report indicating slow-changing indices that are reported with low periodicity and a second stage report indicating fast-changing indices that are reported with high periodicity.

In an embodiment, codebook mode 1 includes N_{g}−1 inter-panel co-phasing values that are indicated by the first stage report and one panel-common inter-polarization co-phasing value that is indicated by the second stage report.

In an embodiment, codebook mode 2 includes 2N_{g}−2 co-phasing values that are indicated by the first stage report and 2N_{g}−1 co-phasing values that are indicated by the second stage report.

In an embodiment, the CSI report is a single-stage report indicating all the co-phasing values in codebook mode 3.

In an embodiment, the first device and the second device are a user equipment and a base station, respectively.

In an embodiment, the first device and the second device are a base station and a user equipment, respectively.

### System Architecture

FIG. 7 shows an exemplary apparatus 700 according to embodiments of the disclosure. The apparatus 700 can be configured to perform various functions in accordance with one or more embodiments or examples described herein. Thus, the apparatus 700 can provide means for implementation of techniques, processes, functions, components, systems described herein. For example, the apparatus 700 can be used to implement functions of a UE or a base station (BS) (e.g., gNB) in various embodiments and examples described herein. The apparatus 700 can include a general-purpose processor or specially designed circuits to implement various functions, components, or processes described herein in various embodiments. The apparatus 700 can include processing circuitry 710, a memory 720, a radio frequency (RF) module 730, and two antenna panels 740 and 750.

In various examples, the processing circuitry 710 can include circuitry configured to perform the functions and processes described herein in combination with software or without software. In various examples, the processing circuitry 710 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 710 can be a central processing unit (CPU) configured to execute program instructions to perform various functions and processes described herein. Accordingly, the memory 720 can be configured to store program instructions. The processing circuitry 710, when executing the program instructions, can perform the functions and processes. The memory 720 can further store other programs or data, such as operating systems, application programs, and the like. The memory 720 can include a read only memory (ROM), a random-access memory (RAM), a flash memory, a solid state memory, a hard disk drive, an optical disk drive, and the like.

The RF module 730 receives a processed data signal from the processing circuitry 710 and converts the data signal to beamforming wireless signals that are then transmitted via the antenna panels 740 and/or 750, or vice versa. The RF module 730 can include a digital to analog convertor (DAC), an analog to digital converter (ADC), a frequency up convertor, a frequency down converter, filters and amplifiers for reception and transmission operations. The RF module 730 can include multi-antenna circuitry for beamforming operations. For example, the multi-antenna circuitry can include an uplink spatial filter circuit, and a downlink spatial filter circuit for shifting analog signal phases or scaling analog signal amplitudes. Each of the antenna panels 740 and 750 can include one or more antenna arrays.

In an embodiment, part of all the antenna panels 740/750 and part or all functions of the RF module 730 are implemented as one or more TRPs (transmission and reception points), and the remaining functions of the apparatus 700 are implemented as a BS. Accordingly, the TRPs can be co-located with such a BS, or can be deployed away from the BS.

The apparatus 700 can optionally include other components, such as input and output devices, additional or signal processing circuitry, and the like. Accordingly, the apparatus 700 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random-access memory (RAM), a read-only memory (ROM), a magnetic disk and an optical disk, and the like. The computer-readable non-transitory storage medium can include all types of computer readable medium, including magnetic storage medium, optical storage medium, flash medium, and solid-state storage medium.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for wireless communication at a first device, comprising:
sending, to a second device, a reference signal for channel state information (CSI) measurement of a channel between the first device and the second device;
receiving, from the second device, a CSI report indicating a transmit precoder matrix indicator (TPMI) that indicates one of a plurality of precoder matrices; and
precoding a to-be-transmitted signal based on the one of a plurality of precoder matrices indicated by the TPMI, where each of the plurality of precoder matrices is able to be used for up to 8-layer transmission.

2. The method of claim 1, wherein the first device is equipped with 8 antenna ports for transmission, the 8 antenna ports being grouped into a single panel or multiple panels.

3. The method of claim 2, wherein the 8 antenna ports are fully coherent to each other.

4. The method of claim 1, wherein the plurality of precoder matrices is classified into three matrix sets each corresponding to one of three codebook modes 1-3, each matrix set including 8 columns of precoder matrices.

5. The method of claim 4, wherein in each matrix set, column 1 defines a general structure, column 2 adds a 180° phase shift for inter-polarization co-phasing values with respect to column 1, column 3 adds a 180° phase shift for inter-panel co-phasing values for all panels with an odd index, with respect to column 1, column 4 adds a 180° phase shift for inter-panel co-phasing values for all panels with an odd index, with respect to column 2, column 5 adds a 90° phase shift for inter-polarization co-phasing values with respect to column 1, column 6 adds a −90° phase shift for inter-polarization co-phasing values with respect to column 1, column 7 adds a 180° phase shift for inter-panel co-phasing values for all panels with an odd index, with respect to column 5, and column 8 adds a 180° phase shift for inter-panel co-phasing values for all panels with an odd index, with respect to column 6.

6. The method of claim 4, wherein N_{g} represents a number of antenna panels that antenna ports of the UE are grouped into, codebook mode 1 includes N_{g} co-phasing values, codebook mode 2 includes 4N_{g}−3 co-phasing values, and codebook mode 3 includes 2N_{g}−1 co-phasing values.

7. The method of claim 6, wherein the CSI report is a dual-stage report including a first stage report indicating slow-changing indices that are reported with low periodicity and a second stage report indicating fast-changing indices that are reported with high periodicity.

8. The method of claim 7, wherein codebook mode 1 includes N_{g}−1 inter-panel co-phasing values that are indicated by the first stage report and one panel-common inter-polarization co-phasing value that is indicated by the second stage report.

9. The method of claim 7, wherein codebook mode 2 includes 2N_{g}−2 co-phasing values that are indicated by the first stage report and 2N_{g}−1 co-phasing values that are indicated by the second stage report.

10. The method of claim 6, wherein the CSI report is a single-stage report indicating all the co-phasing values in codebook mode 3.

11. The method of claim 1, wherein the first device and the second device are a user equipment and a base station, respectively.

12. The method of claim 1, wherein the first device and the second device are a base station and a user equipment, respectively.

13. A first device, comprising:
processing circuitry configured to
send, to a second device, a reference signal for channel state information (CSI) measurement of a channel between the first device and the second device,
receive, from the second device, a CSI report indicating a transmit precoder matrix indicator (TPMI) that indicates one of a plurality of precoder matrices, and
precode a to-be-transmitted signal based on the one of the plurality of precoder matrices indicated by the TPMI, where each of the plurality of precoder matrices is able to be used for up to 8-layer transmission.

14. The first device of claim 13, further comprises 8 antenna ports for transmission, the 8 antenna ports being grouped into a single panel or multiple panels.

15. The first device of claim 14, wherein the 8 antenna ports are fully coherent to each other.

16. The first device of claim 15, wherein the plurality of precoder matrices is classified into three matrix sets each corresponding to one of three codebook modes 1-3, each matrix set including 8 columns of precoder matrices.

17. The first device of claim 16, wherein in each matrix set, column 1 defines a general structure, column 2 adds a 180° phase shift for inter-polarization co-phasing values with respect to column 1, column 3 adds a 180° phase shift for inter-panel co-phasing values for all panels with an odd index, with respect to column 1, column 4 adds a 180° phase shift for inter-panel co-phasing values for all panels with an odd index, with respect to column 2, column 5 adds a 90° phase shift for inter-polarization co-phasing values with respect to column 1, column 6 adds a −90° phase shift for inter-polarization co-phasing values with respect to column 1, column 7 adds a 180° phase shift for inter-panel co-phasing values for all panels with an odd index, with respect to column 5, and column 8 adds a 180° phase shift for inter-panel co-phasing values for all panels with an odd index, with respect to column 6.

18. The first device of claim 16, wherein N_{g} represents a number of antenna panels that antenna ports of the UE are grouped into, codebook mode 1 includes N_{g} co-phasing values, codebook mode 2 includes 4N_{g}−3 co-phasing values, and codebook mode 3 includes 2N_{g}−1 co-phasing values.

19. The first device of claim 18, wherein the CSI report is a dual-stage report including a first stage report indicating slow-changing indices that are reported with low periodicity and a second stage report indicating fast-changing indices that are reported with high periodicity.

20. The first device of claim 19, wherein codebook mode 1 includes N_{g}−1 inter-panel co-phasing values that are indicated by the first stage report and one panel-common inter-polarization co-phasing value that is indicated by the second stage report.

21. The first device of claim 19, wherein codebook mode 2 includes 2N_{g}−2 co-phasing values that are indicated by the first stage report and 2N_{g}−1 co-phasing values that are indicated by the second stage report.

22. The first device of claim 18, wherein the CSI report is a single-stage report indicating all the co-phasing values in codebook mode 3.

23. The first device of claim 13, wherein the first device and the second device are a user equipment and a base station, respectively.

24. The first device of claim 13, wherein the first device and the second device are a base station and a user equipment, respectively.

25. A non-transitory computer-readable medium storing instructions which, when executed by a first device, cause the first device to perform a method comprising:
sending, to a second device, a reference signal for channel state information (CSI) measurement of a channel between the first device and the second device;
receiving, from the second device, a CSI report indicating a transmit precoder matrix indicator (TPMI) that indicates one of a plurality of precoder matrices; and
precoding a to-be-transmitted signal based on the one of a plurality of precoder matrices indicated by the TPMI, where each of the plurality of precoder matrices is able to be used for up to 8-layer transmission.
